(19) United States
(12) Patent Application Publication
(10) Pub. No.: US 2013/0108874 A1
(43) Pub. Date: May 2, 2013

(54) METHOD FOR ASSEMBLING A PART FOR AN AUTOMOBILE

(71) Applicants: Brice Desbois, Tain l'Hermitage (FR); Christophe Gonnet, Roisey (FR)

(72) Inventors: Brice Desbois, Tain l'Hermitage (FR); Christophe Gonnet, Roisey (FR)

(73) Assignee: COMPAGNIE PLASTIC OMNIUM, Lyon (FR)

(21) Appl. No.: 13/497,594

(22) PCT Filed: Sep. 27, 2010
(86) PCT No.: PCT/FR10/52026

§ 371 Date: Dec. 18, 2012

(30) Foreign Application Priority Data
Sep. 28, 2009 (FR) 0956705
Sep. 27, 2010 (FR) PCT/FR2010/052026

(51) Int. Cl. B32B 37/12; B32B 27/08; B32B 15/08; B32B 7/12; B32B 15/01

(52) U.S. Cl. CPC B32B 37/12; B32B 37/1207; B32B 7/12; B32B 37/1292; B32B 15/01; B32B 15/08; B32B 27/08
USPC 428/416; 156/310; 156/295; 428/423.1; 428/425.8; 428/447; 428/414; 428/463; 428/522

(57) ABSTRACT

A method of assembling a part for a motor vehicle is shown. The method comprises the steps of providing at least one of the parts with a first adhesive for bonding with the other part, the first adhesive being activated under the effect of a first predetermined condition, providing at least one of the parts with a second adhesive for bonding with the other part, the second adhesive being different from the first adhesive and suitable for activating under the effect of a second predetermined condition different from the first predetermined condition. The parts are then assembled together by the first adhesive by exposing the parts to the first predetermined condition in such a manner as to define a mutual relative position of the parts in the assembled part, and in the absence of the second predetermined condition, and the assembled-together parts are exposed to the second predetermined condition.

### CROSS-REFERENCE TO RELATED APPLICATIONS

This application is the U.S. National Phase application of PCT/FR2010/052026 filed Sep. 27, 2010, which claims priority to French Application No. 0956705 filed Sep. 28, 2009, which applications are incorporated herein by reference and made a part hereof.

### BACKGROUND OF THE INVENTION

1. Field of the Invention

The present invention relates to the technical field of vehicle parts. Without being restricted thereto, it applies to motor vehicles or indeed to truck type vehicles.

2. Description of the Related Art

In the prior art, a known method of assembling two parts together involves using an adhesive installation. The installation comprises a support for positioning one of the parts relative to the other, the support having two metal portions for holding respective ones of the parts. The installation also includes heater means for heating each part. Each of the metal portions heats the part it is holding by thermal conduction.

Prior to positioning the two parts relative to each other, a bead of a thermosetting adhesive is applied to one and/or the other of the parts for assembling together. Thereafter, the parts are fitted and positioned relative to each other. The parts are then heated by the heater means in order to activate the thermosetting adhesive. Finally, the assembled part is extracted from the installation.

Activating the thermosetting adhesive requires the parts to be heated for a certain length of time. Throughout this time, the installation is occupied, thereby constituting dead time in the method of fabricating the part. The prior art assembly method thus gives rise to a loss of capacity in an installation for assembling parts together.

Furthermore, heating the parts gives rise to a significant energy cost.

Finally, the heater means of the installation make the installation expensive and bulky.

What is needed, therefore, is a method and system of assembly that improves the methods and systems of the prior art.

### SUMMARY OF THE INVENTION

An object of the invention is to provide a method that makes it possible to reduce the capacity loss of an assembly method.

To this end, the invention provides a method of assembling a motor vehicle part that is assembled from first and second parts, the method comprising the steps of:
providing at least one of the first and second parts with an adhesive for bonding with the other part, the adhesive being of a first type that is activated under the effect of at least one first predetermined condition;
providing at least one of the first and second parts with an adhesive for bonding with the other part, the adhesive being of a second type, distinct from the adhesive of the first type, and being activated under the effect of at least one second predetermined condition that is different from the first predetermined condition;
then assembling the first and second parts together by means of the adhesive of the first type, exposing the first and second parts to the first predetermined condition so as to define a mutual relative position for the first and second parts in the assembled part, and in the absence of the second predetermined condition; and
exposing the assembled-together first and second parts to the second predetermined condition.

The method of the invention makes it possible to reduce the capacity loss of the assembly method. The adhesive of the first type serves to bond the parts together merely by exposing them to the first predetermined condition. This initial bonding serves solely to define a mutual relative position of the parts in the assembled part, i.e. to fix the shape of the assembled part, and there is no need for it to be durable or very strong. Once the shape of the assembled part has been fixed, it is possible to extract the assembled part from the installation and to assemble another part. This avoids exposing the parts to conditions that require the installation to be occupied in non-useful manner, and thus to a loss of capacity. Exposing the first and second parts to the second predetermined condition enables the parts to be permanently bonded to each other in a manner that is durable and strong.

In addition, when the second predetermined condition includes supplying heat, the assembly installation does not need to include the means for supplying the heat. This reduces energy costs and installation costs.

The term “in the absence of the second predetermined condition” covers not only the absence of all of the characteristics of the second predetermined condition, but also the partial absence of at least one of these characteristics of the second predetermined condition. The absence of any one of these characteristics prevents the parts being fully subjected to the second condition. The adhesive of the second type thus need not be activated.

The use of adhesives of first and second types enables the fabrication of the first and second parts to be simplified since, at the time of fabricating the first and second parts, there is no need to make provision for bonding means other than adhesive.

In addition, the adhesives provide very good sealing between the first and second parts, in particular compared with mechanical bonding means.

The assembly method is made easier since it is possible to use the same deposition means, e.g. a robot, for providing the first and second parts with the first and second types of adhesive. Furthermore, it is possible to deposit the first and second types of adhesive simultaneously, thereby shortening the length of time the assembly installation is used. The use of adhesives also makes it possible for the method of assembling the part to be completely automated, as contrasted to using mechanical bonding means such as screws for which it is preferable to have an operator present. Since, for safety reasons, the operator cannot act simultaneously with a robot providing the first and second parts with the adhesive, the use of mechanical bonding means such as screws makes the assembly method relatively lengthy and painstaking.

Mechanical bonding means such as screws or staples are usually made of metal and are thus liable to corrosion. Furthermore, as a result of wear or defects, such assembly means run the risk of generating noise in the assembled-together part. Furthermore, the use of adhesives makes it easier to recycle the assembled-together parts, unlike the use of metal bonding means. Finally, adhesives are usually invisible and do not degrade the appearance of the assembled-together part, unlike mechanical bonding means.

The use of a two-sided adhesive film requires a film to be peeled off, thereby giving rise to rejects and being difficult to perform other than by means of an operator. Furthermore, it is easier to deposit adhesives than a two-sided adhesive film, in particular on parts possessing a profile that is complex in three dimensions, where putting such a film into place generally requires an operator to be present. Finally, the fineness of the adhesive film requires the parts to be much more accurately shaped in order to guarantee appropriate spacing, unlike the use of adhesives where the thickness of the deposited bead, which is lightly compressed during assembly, serves to accommodate relatively large gaps between the parts, in particular between parts of large dimensions.

Advantageously, the first predetermined condition comprises exposing the first and second parts to an ambient environment of the first and second parts during at least a first exposure duration.

The ambient environment is defined by all of the normal ambient conditions present in the premises where the assembled part is fabricated. Ambient conditions include in particular ambient temperature, ambient pressure, and ambient humidity.

This first condition is used when the adhesive of the first type comprises a thermoplastic adhesive that is applied hot or an adhesive that is curable at ambient temperature, in particular under the action of the humidity of ambient air.

In addition, this first condition makes it possible for the installation to be occupied for little time, thereby increasing its production capacity.

In an implementation, the second predetermined condition corresponds to delivering heat relative to an ambient environment of the assembled part.

Heat may be delivered by heating, in particular by conduction or by hot air, or by exposing the assembled-together parts to infrared, ultraviolet, or microwave radiation.

In another implementation, the second predetermined condition comprises exposing the first and second parts to an ambient environment of the first and second parts during at least a second exposure duration.

In this other implementation, the second exposure duration is longer than the first exposure duration. During the first exposure duration, the adhesive of the first type is activated but not the adhesive of the second type that has not been exposed to the ambient environment for a sufficient length of time.

Once extracted from the installation, the parts are held together, e.g. at ambient temperature, for a length of time in addition to the first duration of exposure to the ambient environment, with the total exposure duration then being equal to the second exposure duration. There is no need to heat the parts, thereby reducing the energy and installation costs.

According to other characteristics of the method that are optional:

The first and second parts are assembled together in a positioning support for positioning one of the parts. Such a support does not have means for delivering heat, in particular by heating.

The adhesive of the first type comprises a thermoplastic adhesive, and the thermoplastic adhesive is applied hot to at least one of the first and second parts. Under such circumstances, the first condition comprises exposing the parts to ambient temperature over the first exposure duration so as to enable the adhesive to solidify and fix the shape of the assembled part.

The adhesive of the second type comprises a curable adhesive, and the curable adhesive is applied to at least one of the first and second parts. Under such circumstances, the second condition comprises exposing the assembled part to ambient temperature for the second exposure duration. In order to accelerate the second bonding when using a thermosetting adhesive, it is possible in a variant to expose the assembled part to a temperature that is higher than ambient temperature, e.g. by taking advantage of the temperature that is used while applying paint to the assembled part. Preferably, the curable adhesive is applied cold.

A single one of the first and second parts is provided, preferably simultaneously, with both the thermoplastic adhesive and the curable adhesive, each in the form of a bead of adhesive that is continuous or discontinuous.

The invention also provides an assembled part for a motor vehicle, wherein the part comprises first and second parts that are assembled together by a method as described above, and wherein each of the first and second parts is selected from a part made of metal, a part made of thermoplastic material, a part made of thermosetting material, and a hybrid part.

These and other objects and advantages of the invention will be apparent from the following description, the accompanying drawings and the appended claims.

### BRIEF DESCRIPTION OF THE ACCOMPANYING DRAWINGS

The invention can be better understood on reading the following description given purely by way of non-limiting example and made with reference to the drawing, in which:

FIG. 1 shows an assembled part in a first embodiment of the invention;

FIG. 2 shows an enlargement of a zone II of FIG. 1;

FIGS. 3, 4, and 5 are views analogous to the view of FIG. 2 showing an assembled part respectively in second, third, and fourth embodiments of the invention; and

FIG. 6 is a diagrammatic view of an assembly installation.

### DETAILED DESCRIPTION OF THE PREFERRED EMBODIMENTS

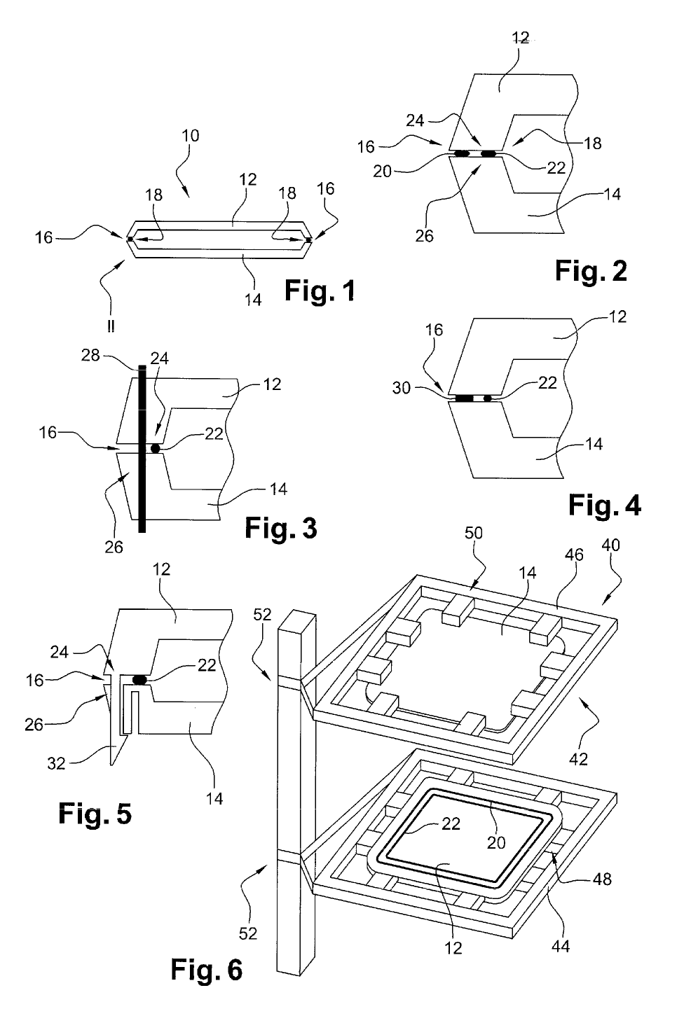

FIG. 1 shows an assembled part given overall reference 10. The part 10 is a bodywork part for a motor vehicle, here a rear module. In a variant, the part 10 may be a structural part such as an upright for an opening. The part 10 may also be a center pillar, a tailgate, or indeed a spoiler.

The assembled part 10 is made up of first and second parts 12 and 14 that are fitted and secured together. The assembled part 10 also has first and second bonding means 16 and 18 for bonding the first and second parts 12 and 14 together.

Specifically, the first part 12 is made of a thermoplastic material, and the second part 14 is made of a thermosetting material. In a variant, the parts 12 and 14 may be made equally well out of metal, out of a thermoplastic material, or out of a thermosetting material. The parts 12 and 14 may also be hybrid parts.

As shown in FIG. 2, the first bonding means 16 comprise a bead 20 of thermoplastic adhesive, and the second bonding means 18 comprise a bead 22 of curable adhesive, here a thermosetting adhesive. The beads 20 and 22 are distributed over a peripheral contact zone 24, 26 of each part 12, 14. Specifically, the thermoplastic adhesive is a single component adhesive and the curable adhesive is of the two-component polyurethane type. The curable adhesive may also be of the two-component epoxy type, of the silicone type, of the acrylic type, or of the single-component polyurethane type that is curable at ambient temperature under the action of humidity. In a variant, the thermoplastic adhesive is a two-component adhesive. In another variant, the means 16 and/or 18 are discontinuous beads of adhesive distributed over the peripheral contact zones 24 and 26 of the parts 12 and 14. In another variant, the means 16 comprise a curable adhesive, e.g. a thermosetting adhesive.

FIGS. 3 to 5 show an assembled part 10 in second, third, and fourth embodiments. Elements analogous to those shown in the above figures are given identical references.

In the second embodiment, the first bonding means 16 comprise staples 28 distributed over the peripheral contact zones 24 and 26 of the parts 12 and 14.

In the third embodiment, the first bonding means 16 comprise a two-sided adhesive film 30.

In the fourth embodiment, the first bonding means 16 comprise spring clips 32 distributed over the peripheral contact zones 24 and 26 of the parts 12 and 14.

FIG. 6 shows an assembly installation 40. The installation 40 comprises a support 42 for positioning one of the parts 12, 14 relative to the other. The support 42 has a first portion 44 for holding the first part 12 and a second portion 46 for holding the second part 14.

Each of the first and second portions 44 and 46 has means 48 and 50 for holding the corresponding part 12, 14, which means are distributed around the circumference of the corresponding portion 44, 46 of the support 42. Specifically, the means 48, 50 comprise pneumatic suction cups. In a variant, the means 48, 50 comprise clamps or indeed electromagnetic means if the parts 12 and 14 are made of metal.

The installation 40 also includes means 52 for moving the portions 44 and 46 relative to each other between a spaced-apart position in which the parts 12 and 14 are positioned in the support 42 and a bonding position in which the parts 12 and 14 are fitted against each other.

The installation 40 does not have heat delivery means, specifically it does not have means for heating by thermal conduction.

There follows a description of a method of the invention. Each part 12 and 14 is initially positioned in the respective means 48, 50. Thereafter, the first part 12 is provided with the first bonding means 16 for bonding with the other part 14. The means 16 are activated under the effect of at least one first predetermined condition. Specifically, heat is applied to the bead 20 of thermoplastic adhesive on the first part 12. The first part 12 is also provided, preferably simultaneously, with second bonding means 18 for bonding with the other part 14. The means 18 are different from the first bonding means 16 and they are activated under the effect of at least one second predetermined condition that is different from the first predetermined condition. Specifically, the bead 22 of curable adhesive is applied to the first part 12, and it is applied cold in this example. In a variant, it is the second part 14 that is provided with the means 18.

Thereafter, the means 52 are used for performing assembly by fitting and positioning the parts 12 and 14 relative to each other while exposing the parts 12 and 14 to the first predetermined condition in order to define a mutual relative position of the parts 12 and 14, and in the absence of the second predetermined condition. Specifically, the first predetermined condition comprises exposing the parts 12 and 14 to an ambient temperature of an ambient environment of the parts 12 and 14 for at least a first exposure duration lying in the range a few seconds to a few minutes.

At the end of the first duration, the assembled part 10 is extracted from the installation 40 and the assembled-together parts 12 and 14 are exposed to the second predetermined condition. Specifically, the second predetermined condition comprises exposing the assembled-together parts 12 and 14 to the ambient temperature of the ambient environment for at least a second exposure duration lying in the range a few minutes to a few hours. Since the parts 12 and 14 have already been exposed to ambient temperature during the first exposure duration, all that remains is the duration corresponding to the difference between the first and second exposure durations until the thermosetting adhesive has cured completely.

In a variant, the second predetermined condition comprises delivering heat. Advantageously, this delivery of heat takes place during a step of painting the assembled part 10. This painting step takes place later than the steps that consist in assembling the parts 12 and 14 together.

The invention is not restricted to the above-described embodiments.

It is possible to assemble together parts 12 and 14 that are pre-painted.

When the bonding means 16 comprise staples 28, the staples 28 are applied after the parts 12 and 14 have been positioned and fitted together.

When the bonding means 16 comprise clips 32, the clips are molded during fabrication of the parts 12 and 14 before the parts 12 and 14 are assembled together.

While the method and system herein described constitute preferred embodiments of this invention, it is to be understood that the invention is not limited to this precise method and system, and that changes may be made therein without departing from the scope of the invention which is defined in the appended claims.

What is claimed is:

1. A method of assembling a motor vehicle part that is assembled from first and second parts, the method comprising the steps of:
providing at least one of said first and second parts with an adhesive for bonding with the other part, said adhesive being of a first type that is activated under the effect of at least one first predetermined condition;
providing at least one of said first and second parts with an adhesive for bonding with the other part, said adhesive being of a second type, distinct from said adhesive of said first type, and being activated under the effect of at least one second predetermined condition that is different from said at least one first predetermined condition;
then assembling said first and second parts together by means of said adhesive of said first type, exposing said first and second parts to said at least one first predetermined condition so as to define a mutual relative position for said first and second parts in said motor vehicle part, and in the absence of said at least one second predetermined condition; and
exposing the assembled-together first and second parts to said at least one second predetermined condition.

2. The method according to claim 1, wherein said at least one first predetermined condition comprises exposing said first and second parts to an ambient environment of said first and second parts during at least a first exposure duration.

3. The method according to claim 1, wherein said at least one second predetermined condition corresponds to delivering heat relative to an ambient environment of said motor vehicle part.

4. The method according to claim 1, wherein said at least one second predetermined condition comprises exposing said first and second parts to an ambient environment of said first and second parts during at least a second exposure duration.

5. The method according to claim 1, wherein said first and second parts are assembled together in a positioning support for positioning one of said first and second parts relative to the other.

6. The method according to claim 1, wherein said adhesive of said first type comprises a thermoplastic adhesive, and said thermoplastic adhesive is applied hot to at least one of said first and second parts.

7. The method according to claim 1, wherein said adhesive of said second type comprises a curable adhesive, and said curable adhesive is applied to at least one of said first and second parts.

8. The method according to claim 6, wherein said adhesive of said second type comprises a curable adhesive, and said curable adhesive is applied to at least one of said first and second parts, and wherein a single one of said first and second parts is provided, preferably simultaneously, with both said thermoplastic adhesive and said curable adhesive, each in the form of a bead of adhesive that is continuous or discontinuous.

9. An assembled part for a motor vehicle, wherein said assembled part comprises first and second parts that are assembled together by a method according to claim 1, and wherein each of said first and second parts is selected from a part made of metal, a part made of thermoplastic material, a part made of thermosetting material, and a hybrid part.

10. A method of assembling a motor vehicle part that is assembled from first and second parts, the method comprising the steps of:
applying a first adhesive to at least one of said first and second parts in order to bond the parts together, said first adhesive being of a first type that is activated under the effect of at least one first predetermined condition;
applying a second adhesive at least one of said first and second parts in order to bond the parts together, said second adhesive being of a second type, distinct from said first adhesive of said first type, and being activated under the effect of at least one second predetermined condition that is different from said at least one first predetermined condition; and
exposing said first and second parts to said at least one first predetermined condition to bond said first and second parts together to provide an assembled-together first and second parts and in the absence of said at least one second predetermined condition; and
exposing said assembled-together first and second parts to said at least one second predetermined condition to activate said second adhesive.

11. The method according to claim 10, wherein said at least one first predetermined condition comprises exposing said first and second parts to an ambient environment of said first and second parts during at least a first exposure duration.

12. The method according to claim 10, wherein said at least one second predetermined condition corresponds to delivering heat relative to an ambient environment of said motor vehicle part.

13. The method according to claim 10, wherein said at least one second predetermined condition comprises exposing said first and second parts to an ambient environment of said first and second parts during at least a second exposure duration.

14. The method according to claim 10, wherein said first and second parts are assembled together in a positioning support for positioning one of said first and second parts relative to the other.

15. The method according to claim 10, wherein said adhesive of said first type comprises a thermoplastic adhesive.

16. The method according to claim 10, wherein said adhesive of said second type comprises a curable adhesive.

17. The method according to claim 15, wherein said adhesive of said second type comprises a curable adhesive, and said curable adhesive is applied to at least one of said first and second parts, and wherein a single one of said first and second parts is provided, preferably simultaneously, with both said thermoplastic adhesive and said curable adhesive.
